(19) United States
(12) Patent Application Publication
(10) Pub. No.: US 2025/0139589 A1
(43) Pub. Date: May 1, 2025

(54) OFFLINE SCHEDULING OF ONLINE MEETINGS

(71) Applicant: Microsoft Technology Licensing, LLC, Redmond, WA (US)

(72) Inventors: Amer Aref HASSAN, Kirkland, WA (US); Bhargavi BASETTY, Redmond, WA (US); Matthew K. VARLEY, Redmond, WA (US); Andrew Y. FRANTSUZOV, Redmond, WA (US)

(21) Appl. No.: 18/385,659

(22) Filed: Oct. 31, 2023

(51) Int. Cl. G06Q 10/1093

(52) U.S. Cl. CPC G06Q 10/1095

(57) ABSTRACT

A method and system for scheduling online meetings while disconnected from a network involves setting an indicator in a meeting invitation when the invitation is generated while a client device is offline. Upon the client device regaining network connectivity, the indicator denoting needed online meeting connection data is processed. In one embodiment, the client device requests meeting connection data from a server, receives the meeting connection data, adds it to the meeting request, and then communicates the meeting request to the server for distribution to the meeting invitees. Alternatively, the client device communicates the meeting request with the indicator to the server. The server recognizes the indicator, requests and adds meeting connection data to the meeting request, and distributes the request to the meeting invitees. By utilizing an indicator set offline by the client device, online meeting requests can be generated and sent when a client device is offline.

### TECHNICAL FIELD

The present disclosure relates to the technical field of computer- and network-based meetings or conferences (e.g., online meetings). More specifically, the present disclosure relates to techniques that facilitate the scheduling of online meetings, while a computing device used by the meeting organizer or scheduler is offline—that is, disconnected from a network.

### BACKGROUND

Online meetings are virtual conferences conducted over the Internet or private networks, enabling geographically distributed meeting participants to connect and communicate through their computers, smartphones, tablets and other hardware executing collaboration or meeting software. These software applications provide audio, video, chat, screen sharing and other features and tools by interfacing with back-end or cloud-based meeting servers using communication and networking protocols. This allows remote meeting participants to meet, communicate, and interact as if physically present together.

The term “online” refers to a state of network connectivity between the client device and a server via network like the Internet. While modern computing devices stay continuously connected through WiFi®, cellular data, and Ethernet, there are still occasions when computing devices go “offline” by losing access to networks. For example, when traveling on an airplane, computer devices must often be disconnected from wireless and cellular networks. In fact, many mobile computing devices include an “Airplane mode” for this very reason. Additionally, devices may lack connectivity when people are traveling in rural areas with poor network coverage. Network outages can also cause temporary offline status when servers or infrastructure equipment fail.

### BRIEF DESCRIPTION OF THE DRAWINGS

Embodiments of the present invention are illustrated by way of example and not limitation in the figures of the accompanying drawings, in which:

FIG. 1 illustrates a computer-networking environment including a client computing device in use by a person traveling on an airplane and attempting to schedule an online meeting while offline disconnected from all computer networks.

FIG. 2 is a diagram illustrating an example of a client meeting application with application logic for receiving from a server one or more instances of meeting connection data, and caching those one or more instances of meeting connection data for use while a client device is offline, consistent with some embodiments.

FIG. 3 is a flow diagram illustrating the method operations performed by a client device as illustrated in FIG. 2, consistent with some embodiments.

FIG. 4 is an example of a user interface that may be deployed with some embodiments.

FIG. 5 is a diagram illustrating an example of a client meeting application, executing on a computing device, with application logic for associating a status value with a meeting request when a meeting request has been generated with meeting data that includes an indication that meeting connection data is to be included with the meeting request while the client executing the application is without a network connection to a server that would otherwise provide the meeting connection data.

FIG. 6 is a flow diagram illustrating a method for associating a status value with a meeting request when generating the meeting request offline, without access to meeting connection data provided by a server, and subsequently processing the meeting request at the client computing device to add the meeting connection data, consistent with some embodiments.

FIG. 7 is a flow diagram illustrating a method for processing, by a server computer, a meeting request with which a software application executing at a client device has associated a status value denoting a need to add to the meeting request meeting connection data, consistent with some embodiments.

FIG. 8 is an example of a user interface that may be deployed with some embodiments.

FIG. 9 is a block diagram illustrating a software architecture, which can be installed on any of a variety of computing devices to perform methods consistent with those described herein.

FIG. 10 illustrates a diagrammatic representation of a machine in the form of a computer system (e.g., a server computer) within which a set of instructions may be executed for causing the machine to perform any one or more of the methodologies discussed herein, according to an example embodiment.

### DETAILED DESCRIPTION

Described herein are techniques for facilitating the scheduling of online meetings while a client computing device lacks a network connection. These techniques include methods, systems, and computer program products or computer-readable media for scheduling online meetings without access to a server that would otherwise provide meeting connection data. In the following description, for purposes of explanation, numerous specific details and features are set forth in order to provide a thorough understanding of the various aspects of different embodiments of the present invention. It will be evident, however, to one skilled in the art, that the present invention may be practiced and/or implemented with varying combinations of the many details and features presented herein.

Online meetings rely on meeting connection data, such as a phone bridge number or a unique URL (uniform resource locater) or web link, to allow meeting participants to join the meeting. This meeting connection data is typically generated when the meeting organizer schedules the meeting through their email, calendar, meeting or conferencing application. The software application with which the meeting organizer schedules the meeting interfaces with one or more back-end servers to obtain a unique phone bridge number, web link, dial-in number, meeting passcode, and so forth, for that particular meeting instance. Using unique instances of meeting connection data prevents unauthorized access to the online meetings. Generating new meeting connection data for each scheduled meeting also avoids conflicts where multiple meetings may be attempting to use the same meeting link or bridge at the same time. Providing unique meeting connection data for each meeting instance enhances the privacy and security of online conferencing.

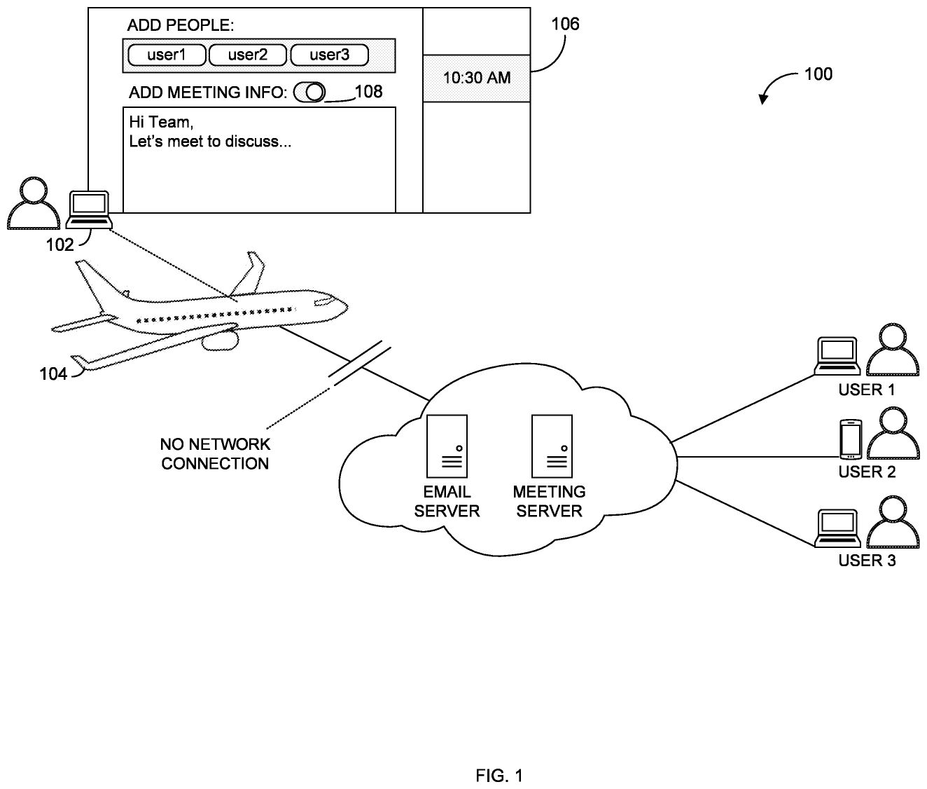

However, a technical problem occurs when the meeting organizer or meeting scheduler needs to schedule a meeting while disconnected from the network and offline, such as when traveling on an airplane without WiFi® or cellular data access, or in any of a significant number of other situations when a network connection is not available. In this offline state, the client application on the meeting organizer's client computing device cannot communicate with the back-end meeting server(s) to obtain the meeting connection data. This technical problem is illustrated and described further in connection with FIG. 1 below.

FIG. 1 illustrates a computer-networking environment 100 including a client computing device 102 in use by a person traveling on an airplane 104 and attempting to schedule an online meeting while offline—that is, disconnected from all computer networks. As shown, the meeting scheduler is interacting with a user interface 106 of a client application on the computing device 102 in order to specify meeting data such as a date and time for the meeting, and meeting participants or invitees. In addition, a graphical user interface element—in this example, a toggle switch 108 with the label, “ADD MEETING INFO”—is presented as part of the user interface 106. When the meeting organizer desires to add meeting connection data to the meeting request or meeting invitation before sending the meeting request, the meeting organizer will select the toggle 108, and in response, the software application will invoke a request, directed to a network-connected server, for the meeting connection data. Under normal circumstances—that is, when the client device 102 has a network connection with the servers 110 and 112—the appropriate server would process the request for meeting connection data by replying to the software application executing on the client device 102 with meeting connection data. However, in this example, because the client device 102 does not have connectivity to any network, the client device 102 cannot communicate with the server that would normally provide the meeting connection data. In fact, in some instances, a graphical user interface element, such as the toggle switch 108, may be inoperable when a network connection to the meeting server is unavailable. For example, the toggle switch 108 may be presented in a specific color, such as grey, to denote that it is temporarily inoperable due to the lack of a network connection.

Without a network connection, the software application executing at the client device 102 has no way to request or obtain from the server(s) the unique meeting connection data. While the meeting organizer can draft the meeting request or invitation, the software application lacks the ability to properly request and acquire the necessary meeting connection data from the server needed to generate a complete meeting invitation. In many cases, this results in meeting requests or meeting invitations being sent out to meeting invitees without the critical details—that is, the meeting connection data—that meeting invitees need to join the online meeting. The software application's inability to retrieve meeting connection data from the server while offline presents a technical challenge. The software application has no technical means to obtain the required meeting connection data when operating without network connectivity. As described further below, this often causes the technical problem of meeting requests or meeting invitations being sent to intended meeting participants or invitees with incomplete information, lacking the essential meeting access details.

In many instances, when a meeting organizer is offline and the software application being used to schedule a meeting cannot obtain meeting connection data, the meeting organizer will send the meeting request or meeting invitation without meeting connection data, with the intention of later updating the meeting invitation with the proper meeting connection data once a network connection has been restored. Accordingly, when the meeting organizer sends the meeting request, because the device is offline, the meeting request is generally added to an outbound messaging queue. When the client device 102 once again establishes a network connection, which in many cases may be hours later, the software application will process messages in the outbound queue and the meeting request will be sent over the network to the inboxes or calendar applications of the intended meeting recipients, without the meeting connection data. Despite the best of intentions, the meeting organizer commonly forgets to follow up by updating the meeting request with the meeting connection data.

As the scheduled meeting time approaches, the meeting invitees who accepted the meeting invitation are presented with reminders by their own software applications, but have no way to join the online meeting since the meeting connection data is missing. This results in a flood of panicked messages from participants seeking the meeting connection data directed to the meeting organizer right before the meeting begins. The meeting organizer is now bombarded with requests while simultaneously scrambling to retrieve the meeting connection data from the server to send out last-minute. This leads to a stressful experience for the meeting organizer. It also creates confusion and frustration for the meeting participants attempting to join the meeting. The end result is an overall poor experience for all parties due to the client application's inability when offline to properly request and obtain the required meeting connection data from the server.

The technical problem described above is addressed by a first technical solution as follows. Consistent with a first embodiment, both the software application executing at the client device (e.g., the client meeting application) and the meeting server responsible for distributing meeting connection data are programmed to include logic for managing the distribution and caching of meeting connection data. When a client meeting application executing at a client device is online with a network connection to the meeting server, the meeting server will communicate over the network to the client device one or more instances of meeting connection data. These one or more instances of meeting connection data are received by the client meeting application and cached locally. Then, when a meeting organizer is interacting with the user interface of the client meeting application to provide meeting data to schedule a meeting while the client device is offline, the client meeting application will detect that the client device is offline and will add or otherwise associate an instance of the meeting connection data stored in the cache to the meeting invitation. If the meeting organizer creates multiple meeting invitations and schedules more than one meeting, the client meeting application will manage the cached meeting connection data to ensure that each individual meeting invitation includes a unique instance of meeting connection data, until all of the instances of meeting connection data in the cached are used up.

When a meeting organizer creates and sends a meeting request while in an offline state, the meeting request is added to an outbound message queue with the meeting connection data obtained from the meeting connection data cache at the client. Accordingly, when the network connection is restored, the messages in the outbound message queue are processed, and any meeting invitations are communicated over the network to the appropriate server(s) for distribution to the meeting invitees. As described in greater detail below, one or more server(s) that receive and process the meeting invitations may, in some instances, perform a verification or validation process to ensure that any meeting connection data added to a meeting invitation while the client device was in an offline state satisfies various requirements.

Consistent with a second embodiment, the technical problem set forth above is addressed by having the client meeting application associate a status value or flag with each meeting request generated while the client device is offline and lacks connectivity. For instance, the status value or flag denotes that the meeting request is intended to have meeting connection data but does not because it was created and sent (e.g., added to the outbound queue) while the client device was offline. When the user interacts with the client meeting application to schedule a meeting and indicates meeting connection data should be included, the application detects it has no network access. In response, instead of retrieving meeting connection data from the server, the scheduling application simply marks the meeting request with a status value or flag denoting that meeting connection data needs to be added to the meeting request.

This status value or flag associated with the meeting request could be implemented through various technical means—for example, by setting a custom metadata field in the meeting request data object, by maintaining a separate database table to track flagged meeting invitations or requests, or by using naming conventions like special prefixes/suffixes.

When network connectivity is restored, the client meeting application processes any queued outbound meeting invitations containing this status value or flag. For meeting requests with the status value set, the client meeting application sends a request to a server to retrieve the meeting connection data. The server provides the meeting connection data, which the client meeting application inserts into the meeting invitation or request. Finally, the client meeting application sends the completed meeting invitation with meeting connection data to a server for distribution to the meeting invitees.

This approach allows the client meeting application to obtain meeting connection data from the server after going back online. The status value provides a lightweight indicator that meeting connection data is needed without requiring a cache of pre-allocated meeting connection data. Overall, this solution resolves the technical problem of clients being unable to properly request meeting connection data while offline.

A third embodiment provides yet another technical solution to the aforementioned technical problem. Consistent with a third embodiment, when the client meeting application creates a meeting invitation offline, the client meeting application still sets a status value or flag indicating that meeting connection data is to be added to the meeting invitation. The meeting invitation is added to the outbound message queue. However, when network connectivity resumes, the client meeting application simply sends the queued messages to a server for processing, rather than processing them locally.

The server contains logic to inspect incoming messages and identify any meeting invitations or meeting requests having a flag or status value set to denote the need for meeting connection data. For any meeting invitations or requests with the status value set, the server makes a request to retrieve the meeting connection data. The server obtains the meeting connection data, inserts the meeting connection data into the meeting invitation, and then distributes the completed meeting invitation to the meeting invitees.

This approach has some technical advantages. It reduces the workload on the client application and shifts processing to the server which may have greater computing resources. The client device does not need to maintain local logic for processing the status values and requesting meeting data. Also, this provides a more centralized architecture—the server has full control over meeting connection data allocation rather than relying on client caches. Overall, this third solution resolves the key technical problem by allowing the server to handle meeting data retrieval when a client creates meeting invitations offline. The client meeting application simply needs to mark meeting invitations as needing meeting connection data, while the server handles processing once connectivity resumes. This approach provides a robust and scalable technical architecture. Other aspects and advantages of the several embodiments will be readily apparent from the description of the several figures that follows.

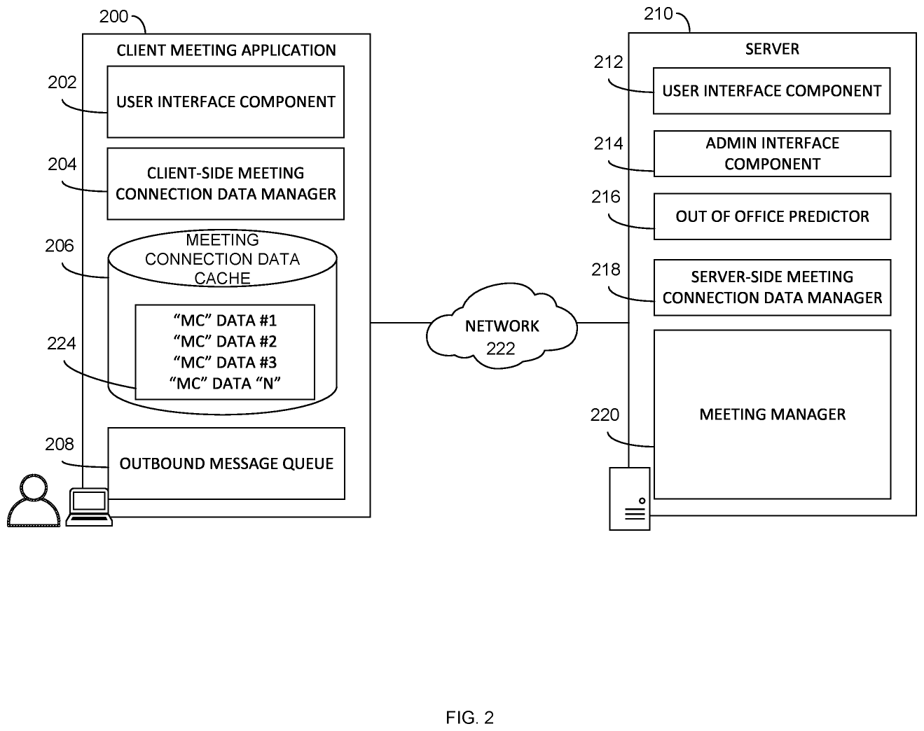

FIG. 2 is a diagram illustrating an example of a client meeting application 200 with application logic for receiving from a server 210 one or more instances of meeting connection data and caching those one or more instances of meeting connection data 224 for use while a client device is offline, consistent with some embodiments. The client meeting application 200 includes several components that work together to facilitate the meeting scheduling process when no network connectivity is available.

The user interface component 202 provides the graphical user interface that allows the user, such as the meeting organizer, to interact with the scheduling application. Through the user interface 202, the user can specify important meeting data such as the date and time of the meeting, email addresses or other identifiers for the meeting invitees or participants, a physical location for the meeting if applicable, and tools or features to be made available during the meeting. The user interface 202 of the client meeting application 200 also includes controls to allow the meeting organizer to indicate whether meeting connection data should be included with a meeting request.

The client-side meeting connection data manager 204 is responsible for handling communications between the client meeting application 200 and the server 210 to obtain and cache instances of meeting connection data. When the client meeting application 200 initially starts and has a network connection, the client-side meeting connection data manager 204 will send one or more requests to the server 210 for meeting connection data instances. When these instances are received from the server 210 over the network 222, the client-side meeting connection data manager 204 stores the individual instances of meeting connection data locally in the meeting connection data cache 206. The meeting connection data manager 204 includes logic to request an adequate number of meeting connection data instances during online operation so that a sufficient quantity exists in the cache for use when the device is offline. In some instances, the number of instances of meeting connection data available to a user may be controlled by an administrator, using the administrative interface component 214 of the server 210.

The meeting connection data cache 206 provides local storage on the client device for instances of meeting connection data 224 received from the server 210. This cache 206 serves as the data source when the client device does not have network connectivity and cannot retrieve meeting connection data directly from the server 210. The cache 206 may be implemented using various storage technologies, such as allocating a portion of main memory to store the data, using static memory specifically provisioned for the cache, or storing the meeting connection data instances on a disk or other secondary storage device.

The outbound message queue 208 contains any messages, such as meeting requests, that were created while the device was offline and are now waiting to be sent over the network 222 when connectivity resumes. This queue 208 ensures that meeting requests and other messages are sent to the server 210 in the proper order when the client transitions back to being online. The queue 208 prevents messages created earlier offline from being blocked and sent after messages created later during the online state.

When a user interacts with the client meeting application 200 to schedule a meeting while offline, the application logic detects that no network connectivity exists. In response, instead of attempting to contact the server 210, or, after attempting to content the server 210 and receiving a timeout or error message, the client meeting application 200 retrieves an instance of meeting connection data from the local cache 206 to include with the meeting request. The meeting request, with the meeting connection data, is then placed in the outbound message queue 208 to be processed later when network access is restored.

Subsequently, when the client device regains network connectivity, the client meeting application 200 processes the messages in the outbound queue 208 sequentially. Any meeting requests in the queue 208 that contain meeting connection data originating from the client's cache 206 are sent over the network 222 to the server 210 for further processing and distribution to the specified meeting attendees.

After receiving meeting requests that contain cached meeting connection data, the server 210 may validate the meeting connection data to ensure compatibility and security policies are followed and prevent potential conflicts. For example, the server may compare the data against an internal store of values. In addition, the server validates the meeting connection data to ensure it is not stale or obsolete. The meeting connection data may have an expiration time or date associated with it. If the data is too old, the server may reject it and request fresh connection data to mitigate the risk of changes to the server invalidating the cached data. Overall, the client-side cache allows offline scheduling to occur, while the server-side logic maintains integrity and consistency of meeting data by confirming the connection data is valid and current.

The server 210 includes both an admin interface component 214 and a user interface component 212. Consistent with some embodiments, the user interface component 212 provides a web portal that allows users to manage the process by which the server provides meeting connection data to client meeting applications. For example, via the user interface portal, an end-user may request access to meeting connection data for their client application. The user interface 212 also allows users to configure parameters associated with individual instances of meeting connection data cached at client devices. Some examples of configurable parameters include:
Enabling/disabling automated recording of meetings utilizing the connection data
Setting audio and video quality levels
Allowing access to meetings before scheduled start time
Enabling waiting rooms for attendees
Muting all attendees upon entry
Limiting screen sharing abilities
Requiring passwords or PINs for entry
Enabling live captions or transcriptions
Integrating with third-party apps like whiteboards

Consistent with some embodiments, the admin interface 214 provides configuration capabilities to control user access and policies for meeting connection data. For example, administrators can specify which end-users are permitted to cache meeting connection data based on their roles and permissions. The admin interface allows configuring the expiration time for cached data, such as setting a limit of two weeks before cached connection data is purged. Administrators can also control the number of meeting connection data instances each user can cache, like allowing managers to cache ten instances but other employees only five instances. Additionally, the admin interface is used to define which parameters can be customized when a user configures each cached connection data set. The administrator selects from options like recording, transcriptions, waiting rooms, etc. to determine the available configuration choices. The customized options are then presented to users when they preconfigure individual cached instances of meeting connection data via the server-based user interface. In summary, the admin portal allows centralized control over meeting connection data access, expiration, volume, and configuration options.

The server-side meeting connection data manager 218 keeps track of meeting connection data distribution and usage. For each user, it stores the specific instances of meeting connection data that have been allocated to their account. When the server 210 receives a meeting request with cached meeting connection data from a client device 200, the meeting connection data manager 218 verifies that the included data matches what was previously allocated to that user. It then marks that specific meeting connection data instance as used. By tracking usage, the meeting connection data manager 218 can determine when a user is running low on allocated instances. When a user's cache falls below a threshold, the server-side meeting connection data manager 218 can proactively prompt the user through the client application 200 to obtain more instances of meeting connection data to replenish his or her supply. This allows the meeting connection data manager 218 to closely govern meeting connection data distribution for each user.

As shown in FIG. 2, with some embodiments, the server includes an out of office predictor component 216 that utilizes machine learning models trained to predict when users are likely to need offline access to meeting connection data. The models analyze multiple factors to make personalized predictions for each user. For example, the models look at historical patterns in the user's calendar data to detect recurring events like weekly status meetings or regular conference trips. The models also analyze past frequency of the user scheduling meetings while offline or disconnected. Location data such as recent travel combined with calendar entries containing flight details could indicate an upcoming trip where offline access will be needed. Information about when the user is out of office, on vacation, or has an all-day event can also improve the quality of predictions. The models are continuously trained and updated based on new data. When the predictor component 216 forecasts a high likelihood a specific user will need to cache meeting connection data, the server 210 can proactively prompt that user to cache additional meeting connection data instances. This personalized, predictive approach allows the system to intelligently assist users in preparing for upcoming offline periods and travel. The machine learning models maximize the likelihood users will have adequate cached meeting connection data when offline and avoid disruptions to their productivity and meeting scheduling. In some embodiments, the out of office predictor may be deployed using a rules-based approach, as opposed to a predictive system based on trained machine learning models.

The server-side meeting connection data manager 218 implements various techniques to ensure each instance of meeting connection data that is distributed to a client device of a user is unique, thereby preventing conflicts where two meetings may be assigned the same connection data. One approach to preventing such conflicts involves assigning each meeting connection data instance a unique identifier (ID) that is checked against a database before allocation to verify it is not already in use. The meeting connection data manager 218 can also maintain a schedule of upcoming meeting times mapped to the in-user meeting connection data, validating availability before distribution. Setting an expiration date on distributed meeting connection data enables safe reuse after a certain time period. Additionally, when a scheduled meeting is confirmed, the meeting connection data manager 218 can replace the cached connection data with fresh data to avoid overlap. For phone bridge numbers, the manager 218 will compare against previously used numbers stored in a database to guarantee uniqueness. For web URLs, it can generate random unique strings. By leveraging user IDs, meeting IDs, and database checks, the meeting connection data manager 218 can prevent conflicts through various robust techniques.

In some embodiments, the meeting connection data manager 218 maintains a mapping of meeting connection data to the backend physical resources that will be utilized for the meeting. For example, each phone bridge number may be mapped to a specific conferencing bridge resource. If a conflict between instances of meeting connection data is detected—like two meetings allocated the same bridge number at the same time—the meeting connection data manager can update the mapping instead of changing the meeting connection data itself. For example, Meeting A has been assigned bridge number 555-1234 mapped to Bridge 1. Meeting B is later assigned the same 555-1234 number also mapped to Bridge 1. The meeting connection data manager detects this conflict. Instead of assigning a new number to Meeting B, it simply updates the mapping for Meeting B to use Bridge 2 instead of Bridge 1. The meeting connection data (phone number 555-1234) remains unchanged.

This approach avoids the need to modify the meeting connection data that has already been distributed to attendees. By remapping resources behind the scenes, conflicts can be resolved transparently. The meeting connection data manager uses its resource mapping layer as an abstraction to separate the meeting data from the underlying infrastructure. This provides flexibility to quickly handle conflicts through remapping rather than reassignment.

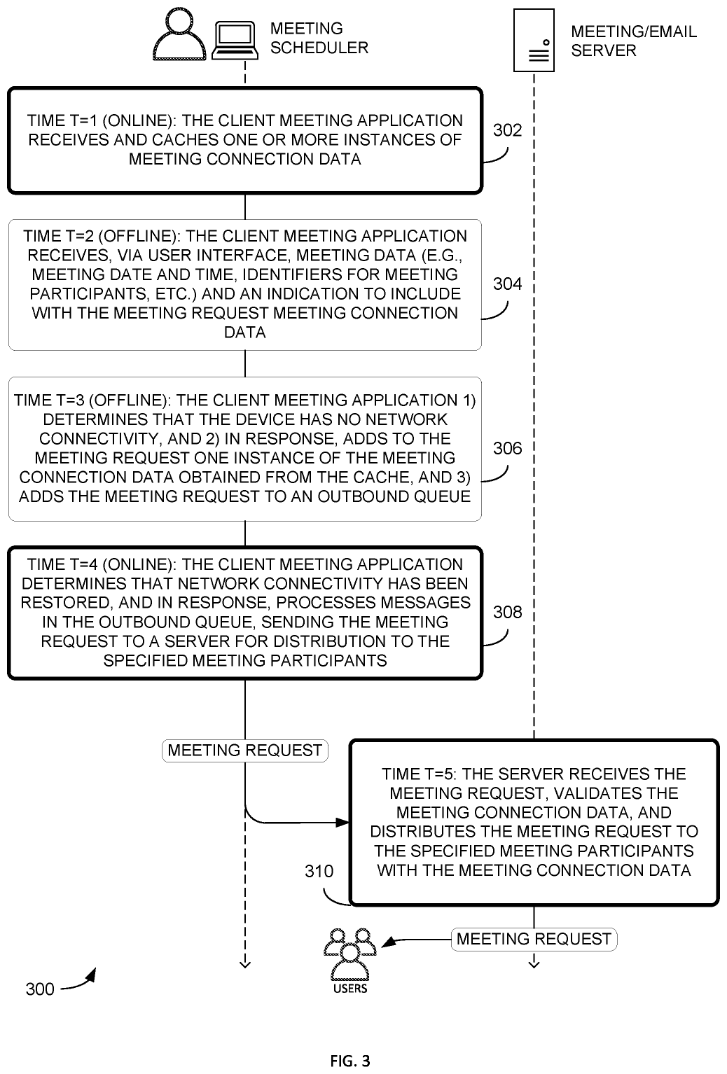

FIG. 3 is a flow diagram illustrating the method operations of a method 300 performed by a client device executing a client meeting application as illustrated in FIG. 2, consistent with some embodiments. First, at method operation 302, at time T=1, when the client meeting application is online and connected to the meeting server via the network, the client meeting application receives from the server and caches one or more instances of meeting connection data. This allows meeting connection data to be stored locally, for use by the client meeting application when the client device is offline.

At method operation 304, at time T=2 when the client device is offline, the client meeting application receives via the user interface meeting data for the scheduling of an online meeting, such as date/time and email addresses or other identifiers of meeting participants. The client meeting application also receives an indication to include meeting connection data with the meeting request. This indication may be received by the client meeting application as a result of the meeting organizer selecting or otherwise interacting with a particular graphical user interface (GUI) element of the user interface, or alternatively, when the meeting organizer initiates the scheduling task by selecting a type of message or event (e.g., an online meeting request) to create.

At method operation 306 at time T=3, while the client device remains offline, the client meeting application detects that the client device has no network connectivity. For example, in response to the meeting organizer specifying that meeting connection data should be added to the meeting request, the client application may attempt to make a network request to a known server address and port, such as the meeting server URL. If the request times out after a certain period of waiting for a response, or an error is returned indicating no network connection, the client meeting application determines there is no active network connectivity. Alternatively, the client meeting application may register for system or device broadcasts about network state changes. When the client meeting application receives a broadcast indicating network disconnect, the application will log that the network connection has been lost. In either case, when the application determines it is offline while it is attempting to add to the meeting request the meeting connection data, the application will associate or add to the meeting request an instance of the meeting connection data obtained earlier and stored locally in the cache. When the meeting organizer attempts to send the meeting request, because the client device is offline, the client meeting application will add the meeting request, with the meeting connection data, to the outbound queue to be sent later.

At method operation 308, at time T=4 when network connectivity has been restored, the client meeting application processes the outbound message queue and sends the meeting request containing the meeting connecting data obtained from the cache to the server for distribution to the specified meeting invitees.

At method operation 310, at time T=5, the server receives the meeting request, validates the meeting connection data that originated from the client's cache, and distributes the meeting request with the validated meeting connection data to the meeting invitees. This ensures that those meeting invitees who accept the meeting invitation will be able to properly join the meeting at the scheduled date and time.

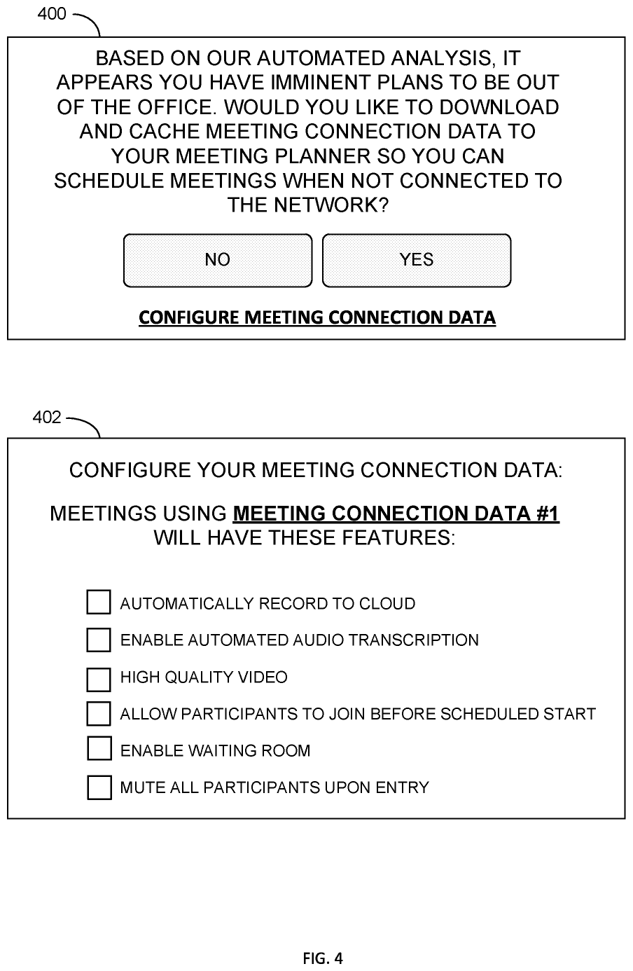

FIG. 4 is an example of a user interface that may be deployed with some embodiments, such as those described in connection with FIGS. 2 and 3. Consistent with some embodiments, the meeting server includes logic to predict the likelihood that a user will schedule meetings while offline and disconnected from the network. This prediction logic can be implemented using one or more pre-trained machine learning models, or alternatively using a rules-based system analyzing factors and patterns in the user's data. The prediction logic may take into account the user's past history of scheduling meetings, including metrics such as the number of meetings scheduled and whether they were scheduled while online or offline.

Additionally, the prediction logic may factor in the user's location history and frequency of traveling to determine when they are likely to need offline access to meeting connection data. Based on the output from the prediction logic, the server can proactively send a message to the user's client meeting application prompting the user to cache additional sets of meeting connection data when the user is predicted to have a high chance of scheduling meetings offline in the near future. For example, if the user has a trip scheduled for the following week, the server may detect this and notify them to cache extra meeting connection data in advance of the trip dates. This allows the client meeting application to proactively ensure adequate meeting connection data is available for the user's upcoming offline scheduling needs.

The user interface 400 shown in FIG. 4 illustrates an example of a prompt displayed to a user when the meeting server predicts the user may need additional cached meeting connection data based on upcoming travel or time away from network connectivity. The interface 400 includes text explaining to the user that based on automated analysis, it appears the user has imminent plans to be out of the office and may need to schedule meetings offline. Below the explanatory text are two options presented to the user. The first option is a button labeled “No” allowing the user to decline downloading additional cached meeting connection data if the user believe it will not be needed. The second option is a button labeled “Yes”, which the user can click to confirm they would like to download and cache instances of meeting connection data to their client meeting application.

If the user selects “Yes”, a configuration interface 402 may be displayed to customize the meeting connection data that will be cached. This interface allows the user to define specific parameters for a meeting, such as automatically recording the meeting to the cloud, enabling transcription, configuring the video quality, and other options. After configuring the meeting data, the user can click a button such as “Download Meeting Data” to cache the configured data sets locally for use in scheduling meetings offline when traveling or disconnected.

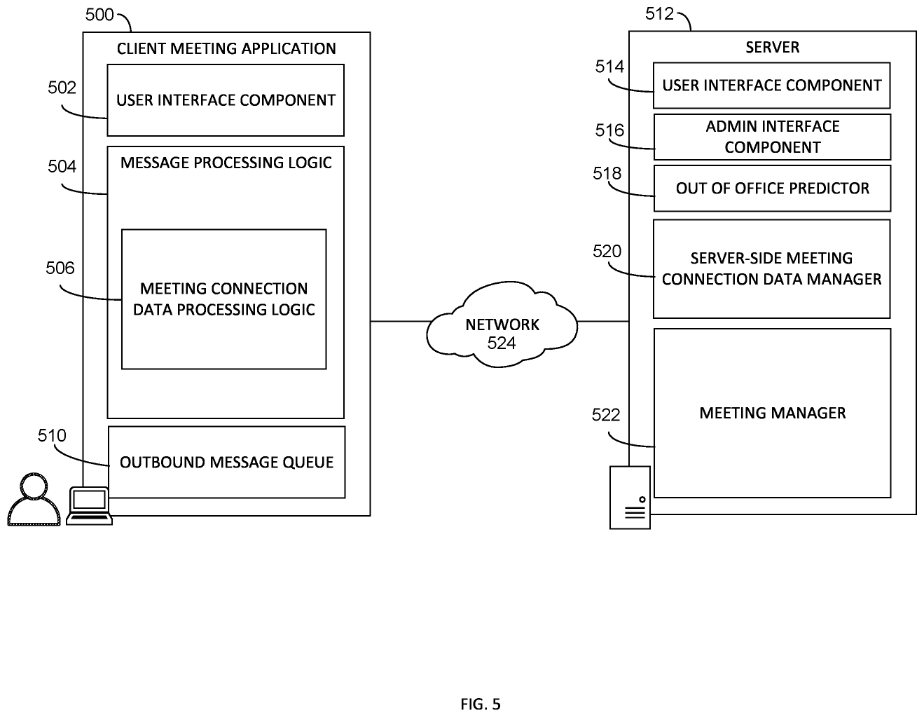

FIG. 5 is a diagram illustrating an example of a client meeting application, executing on a computing device, with application logic for associating a status value or flag with a meeting request when a meeting request has been generated with meeting data that includes an indication that meeting connection data is to be included with the meeting request, while the client executing the application is without a network connection to a server that would otherwise provide the meeting connection data. Unlike the previous embodiment which relies on a client-side cache, the application architecture illustrated in FIG. 5 does not store meeting connection data locally, at the client device. Instead, the client meeting application includes application logic to set a status value or flag to indicate meeting connection data is needed when offline.

Referring to FIG. 5, client-side user interface component 502 allows the meeting organizer to create a meeting request and indicate that meeting connection data should be included, just like a normal online scheduling scenario. However, when the meeting organizer attempts to add the meeting connection data, or when the meeting organizer attempts to send the message, while offline, the message processing logic 504 detects that the client device has no network connectivity, and in response, sets a status value or flag for the meeting request. Accordingly, the message representing the meeting request is added to the outbound message queue 510 with a status value or flag that has been set to indicate that the meeting request needs meeting connection data. That is, when the status value for a particular meeting request is set to a specific value, or has a flag set, the meeting request is intended to have meeting connection data but does not yet have meeting connection data.

The status value or flag indicating that meeting connection data needs to be added to a meeting request can be implemented in various ways. One approach is to add a custom data element, metadata field, or property to the data structure or object representing the meeting request itself. This data element would contain the status value denoting meeting connection data is required. A second approach is maintaining a separate database table or log, at the client device, to track meeting requests needing connection data. An entry would be added for each meeting request, comprising the status value and a pointer or reference to the actual meeting request data. A third approach is using naming conventions by adding a special prefix or suffix to meeting requests flagged as needing data. For example, adding “NO_CONNECT” or “_ADD_DATA” to the subject line or name of a meeting request created offline. The application logic could check for these patterns in names to identify meeting invites needing meeting connection data, before sending the meeting request to a server for distribution to the meeting invitees.

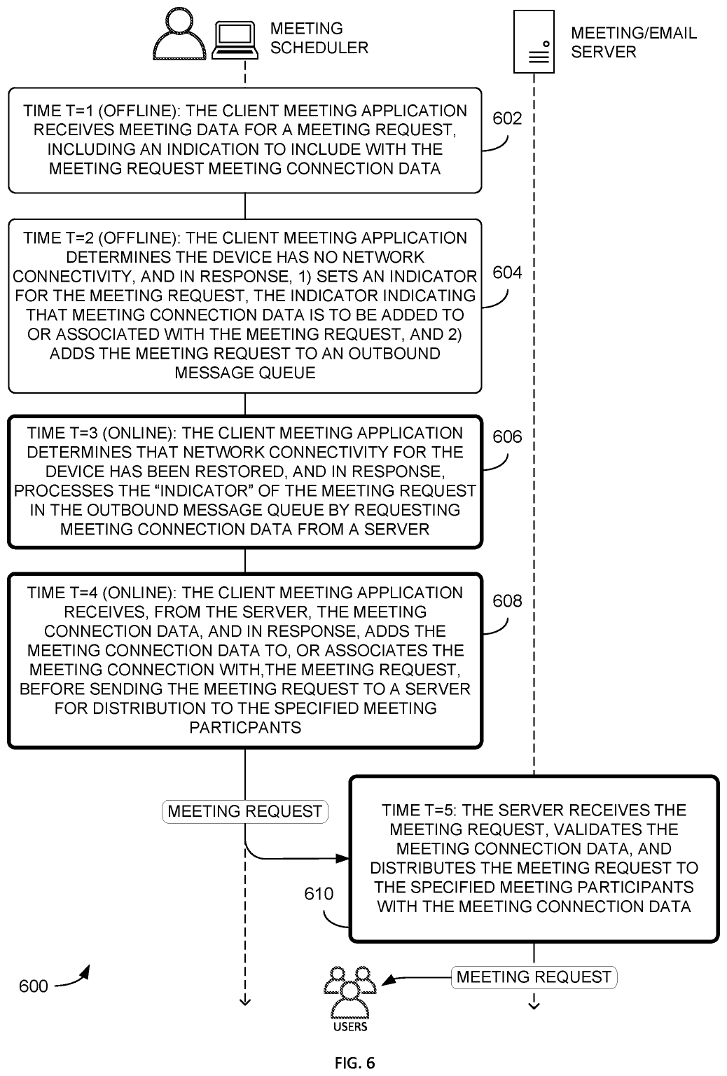

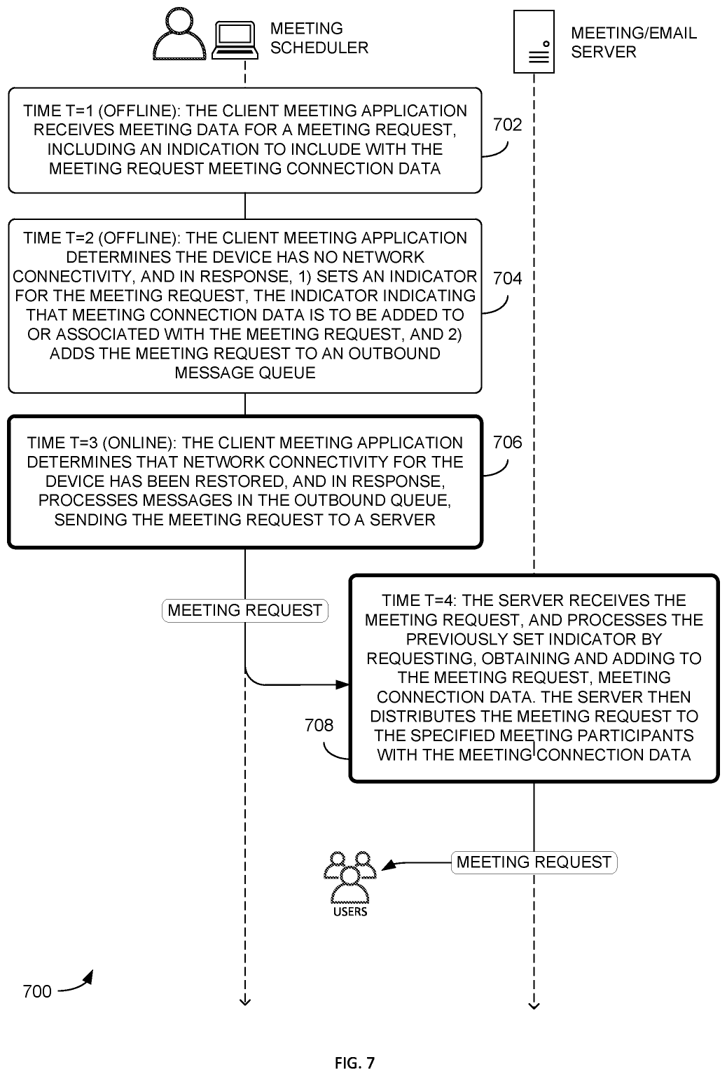

After a meeting request or meeting invitation associated with a status value or flag has been added to the outbound message queue while offline, there are two options for subsequently adding the meeting connection data to the meeting request or meeting invitation before sending the meeting request to the meeting invitees. As illustrated in more detail and described in connection with FIG. 6 (client-side) and FIG. 7 (server-side), the meeting connection data can be added by logic executing at the client device after the client detects that the client has regained network connectivity. Alternatively, the meeting request, with the set status value or flag, can be sent by the client meeting application to a server for processing, and logic at the server can handle obtaining and adding the meeting connection data by processing the status indicator in meeting requests received from clients.

FIG. 6 is a flow diagram illustrating a method 600 for associating a status value with a meeting request when generating the meeting request offline, without access to meeting connection data provided by the meeting server, and subsequently processing the meeting request at the client computing device to add the meeting connection data, consistent with some embodiments. First, at method operation 602 at time T=1, the client meeting application receives meeting data for a meeting request while the client device is offline. The meeting data includes, for example, a date and time for the meeting, the names or identifiers (e.g., email address, usernames, handles, etc.) of the individual meeting invitees who are being invited to participate, and an indication to include meeting connection data so that the meeting can be conducted online.

At method operation 604, at time T=2, the client meeting application determines the client device has no network connectivity while it remains offline. This determination may occur dien the user interacts with the meeting application's user interface to indicate that meeting connection data should be added to a meeting request they are generating. For example, upon receiving this indication from the user, the client application may attempt to send a request to the meeting server to retrieve the meeting connection data. Alternatively, the client meeting application may invoke a request directed to the server, to obtain Meeting connection data, in response to the meeting organizer sending the meeting request which, because there is no network connection, results in the meeting request being added to the outbound message queue. In either case, since there is no network connectivity, the request will timeout or return an error message. In response to detecting the failed attempt to contact the server due to lack of network connectivity, the client meeting application takes two steps First, the client meeting application will sets a status value, flag, or other indicator within the data representing the meeting request. This status denotes that meeting connection data needs to be retrieved and added to the meeting request before the meeting request is delivered to the meeting invitees Additionally, after setting the status value, when the user interacts with the user interface to send the meeting request, since the device is still offline, the request is added to a local outbound message queue rather than being transmitted over the network. Adding the meeting request with the status indicator to this outbound message queue allows the client application to process the request later when network connectivity resumes.

At method operation 606, at time T=3, the client meeting application determines that network connectivity for the client device has been restored. This may occur by the device receiving a system broadcast indicating that WiFi® or cellular data connectivity is available. Alternatively, the client meeting application may periodically make a status request to determine network connection availability. In response to detecting the client now has network access, the client meeting application processes the meeting requests in the outbound message queue that were added while offline. For any meeting request that contains the status value indicating meeting connection data needs to be added, the client meeting application takes action. Specifically, the client meeting application sends a request over the network to the meeting server to retrieve meeting connection data.

A method operation 608, at time T-4, the client meeting application receives the network connection data from the server. The client meeting application then takes the meeting connection data and updates the corresponding meeting request by adding the dial-in number, web URL, and other access details.

Finally, at method operation 610 at time T=5, the client meeting application sends the completed meeting request containing all necessary data over the network to the appropriate server for distribution to the meeting invitees. In this manner, the client meeting application is able to process meeting requests created offline by using the status value to obtain and add meeting connection data once network connectivity resumes.

FIG. 7 is a flow diagram illustrating a method for processing, by a server computer, a meeting request with which a software application executing at a client device has associated a status value denoting a need to add to the meeting request meeting connection data, consistent with some embodiments. At method operation 702 at time T=1, the client meeting application receives meeting data for a meeting request while the client device is offline. The meeting data includes, for example, a date and time for the meeting, the names or identifiers (e.g., email address, usernames, handles, etc.) of the individual meeting invitees who are being invited to participate, and an indication to include meeting connection data so that the meeting can be conducted online.

At method operation 704 at time T=2, while the client device is still offline, the client meeting application. This determination may occur when the user interacts with the meeting application's user interface to indicate that meeting connection data should be added to a meeting request they are generating. For example, upon receiving this indication from the user, the client application may attempt to send a request to the meeting server to retrieve the meeting connection data. Alternatively, the client meeting application may invoke a request directed to the server, to obtain. Meeting connection data, in response to the meeting organizer sending the meeting request, which, because there is no network connection, results in the meeting request being added to the outbound message queue. In either case, since there is no network connectivity, the request will timeout or return an error message. In response to detecting the failed attempt to contact the server due to lack of network connectivity, the client meeting application takes two steps. First, the client meeting application will sets a status value, flag, or other indicator within the data representing the meeting request. This status denotes that meeting connection data needs to be retrieved and added to the meeting request before the meeting request is delivered to the meeting invitees. Additionally, after setting the status value, when the user interacts with the user interface to send the meeting request, since the device is still offline, the request is added to a local outbound message queue rather than being transmitted over the network. Adding the meeting request with the status indicator to this outbound message queue allows the client application to process the request later when network connectivity resumes.

At method operation 706, at time T=3, the client meeting application determines that network connectivity for the client device has been restored. This may occur by the device receiving a system broadcast indicating that WiFi® or cellular data connectivity is available. Alternatively, the client meeting application may periodically make a status request to determine network connection availability. In response to detecting the client now has network access, the client meeting application processes the messages in the outbound message queue that were added while offline. However, instead of the client meeting application processing each meeting request that has a status value set to denote the need for meeting connection data, the client meeting application simply processes the outbound message queue by sending each message, including meeting requests, to a server.

At method operation 707, at time T=4, the server receives a meeting request that has a status value or flag set to denote the need for meeting connection data. In response, the server makes a request to the appropriate service for the meeting connection data, and then receives the meeting connection data, and adds the meeting connection data to the meeting request. Finally, the meeting request is distributed to the meeting invitees, with the meeting connection data.

In some cases, a meeting request created by a client meeting application may be communicated to the meeting invitees before a server has added the meeting connection data. This may occur, for example, when the meeting scheduling and message deliver services are handled by separate backend services, systems or clusters. For example, a meeting request may be delivered by an email or messaging server before the meeting server can process the status indicator and add in the meeting connection data. In such a scenario, the meeting server may maintains its own records of scheduled meetings, including a field similar to the status value or flag, noting if a meeting needs meeting connection data.

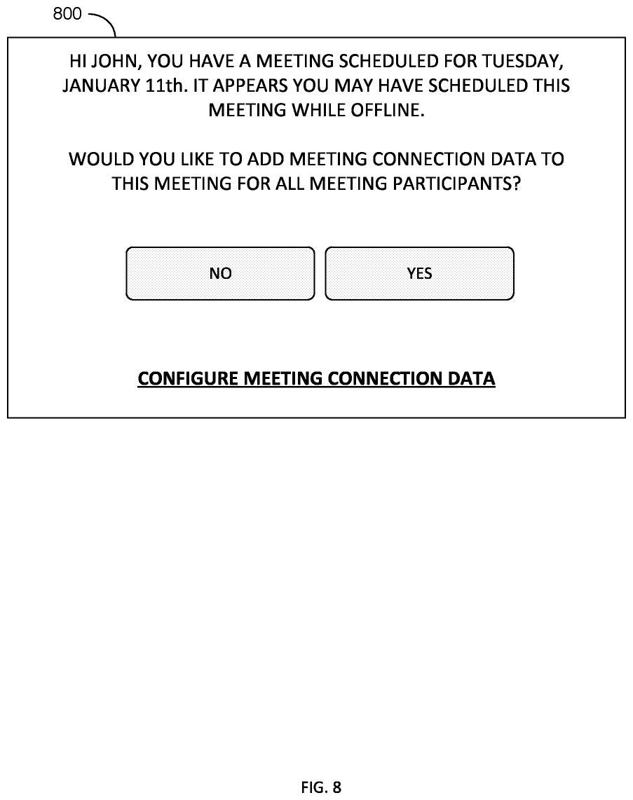

Periodically, the meeting server may execute a process to check its records of upcoming meetings. If any are found that have the indicator set denoting the scheduled meeting requires meeting connection data, but the server's record shows no meeting connection data has been added yet, the meeting server will take action. Specifically, the meeting server will send a message to the client meeting application of the meeting organizer asking the meeting organizer to confirm if meeting connection data should be added for the scheduled meeting. This message may be an email, SMS, pop-up dialog, or other communication channel. An example of such a user interface is presented in FIG. 8

### Machine and Software Architecture

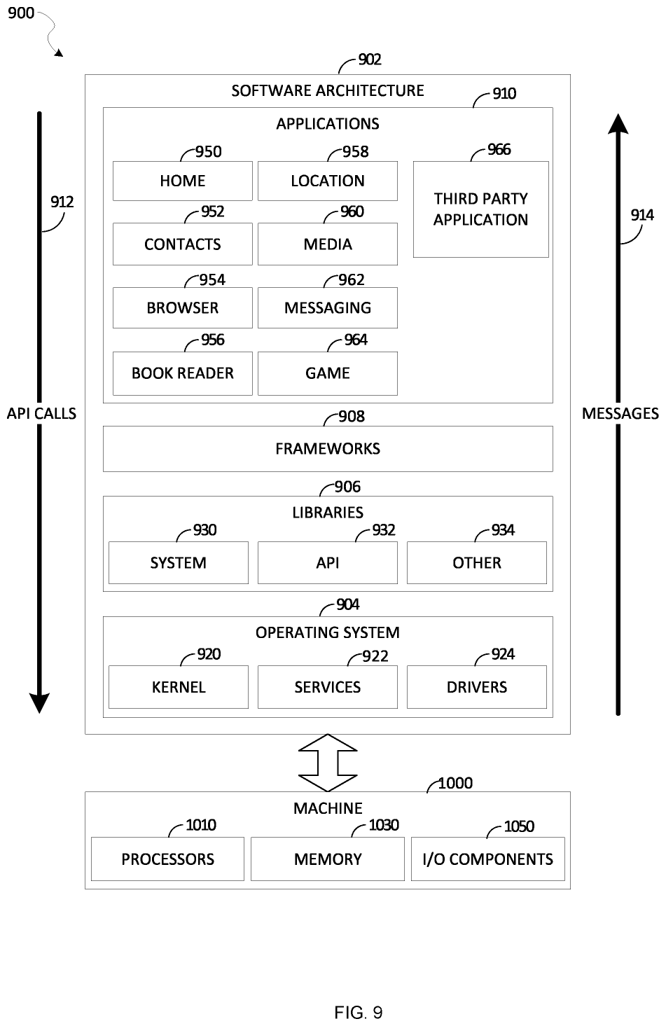

FIG. 9 is a block diagram 900 illustrating a software architecture 902, which can be installed on any of a variety of computing devices to perform methods consistent with those described herein. FIG. 9 is merely a non-limiting example of a software architecture, and it will be appreciated that many other architectures can be implemented to facilitate the functionality described herein. In various embodiments, the software architecture 902 is implemented by hardware such as a machine 800X of FIG. 8 that includes processors 810, memory 830, and input/output (I/O) components 850. In this example architecture, the software architecture 902 can be conceptualized as a stack of layers where each layer may provide a particular functionality. For example, the software architecture 802 includes layers such as an operating system 904, libraries 906, frameworks 908, and applications 910. Operationally, the applications 910 invoke API calls 912 through the software stack and receive messages 914 in response to the API calls 912, consistent with some embodiments.

In various implementations, the operating system 904 manages hardware resources and provides common services. The operating system 904 includes, for example, a kernel 920, services 922, and drivers 924. The kernel 920 acts as an abstraction layer between the hardware and the other software layers, consistent with some embodiments. For example, the kernel 920 provides memory management, processor management (e.g., scheduling), component management, networking, and security settings, among other functionality. The services 922 can provide other common services for the other software layers. The drivers 924 are responsible for controlling or interfacing with the underlying hardware, according to some embodiments. For instance, the drivers 924 can include display drivers, camera drivers. BLUETOOTH® or BLUETOOTH® Low Energy drivers, flash memory drivers, serial communication drivers (e.g., Universal Serial Bus (USB) drivers). Wi-Fi® drivers, audio drivers, power management drivers, and so forth.

In some embodiments, the libraries 906 provide a low-level common infrastructure utilized by the applications 910. The libraries 906 can include system libraries 930 (e.g., C standard library) that can provide functions such as memory allocation functions, string manipulation functions, mathematic functions, and the like. In addition, the libraries 906 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 906 can also include a wide variety of other libraries 934 to provide many other APIs to the applications 910.

The frameworks 908 provide a high-level common infrastructure that can be utilized by the applications 910, according to some embodiments. For example, the frameworks 908 provide various GUI functions, high-level resource management, high-level location services, and so forth. The frameworks 908 can provide a broad spectrum of other APIs that can be utilized by the applications 910, some of which may be specific to a particular operating system 904 or platform.

In an example embodiment, the applications 910 include a home application 950, a contacts application 952, a browser application 954, a book reader application 956, a location application 958, a media application 960, a messaging application 962, a game application 964, and a broad assortment of other applications, such as a third-party application 966. According to some embodiments, the applications 910 are programs that execute functions defined in the programs. Various programming languages can be employed to create one or more of the applications 810, structured in a variety of manners, such as object-oriented programming languages (e.g., Objective-C. Java, or C++) or procedural programming languages (e.g., C or assembly language). In a specific example, the third-party application 966 (e.g., an application developed using the ANDROID™ IOS™ software development kit (SDK) by an entity other than the vendor of the particular platform) may be mobile software running on a mobile operating system such as IOS™, ANDROID®, WINDOWS®, Phone, or another mobile operating system. In this example, the third-party application 866 can invoke the API calls 912 provided by the operating system 904 to facilitate functionality described herein.

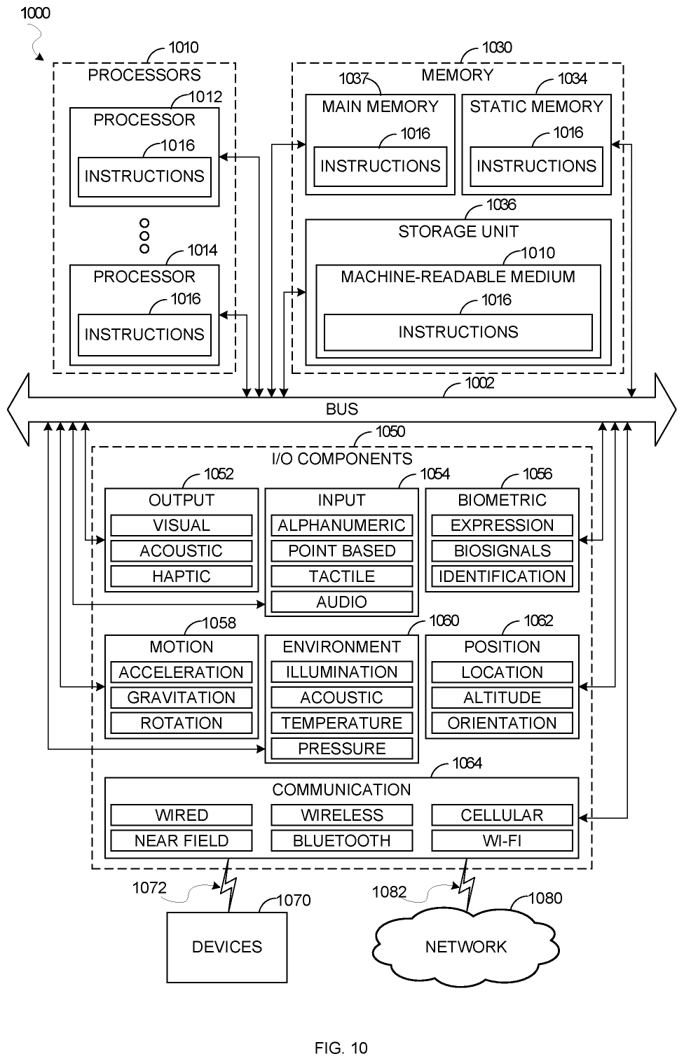

FIG. 10 illustrates a diagrammatic representation of a machine 1000 in the form of a computer system within which a set of instructions may be executed for causing the machine to perform any one or more of the methodologies discussed herein, according to an example embodiment. Specifically, FIG. 10 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example the instructions 1016 may cause the machine 1000 to execute any one of the methods or algorithmic techniques described herein. Additionally, or alternatively, the instructions 1016 may implement any one of the systems described herein. The instructions 1016 transform the general, non-programmed machine 1000 into a particular machine 1000 programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 916 to perform any one or more of the methodologies discussed herein.

The machine 1000 may include processors 1010, memory 1030, and I/O components 1050, which may be configured to communicate with each other such as via a bus 1002. In an example embodiment, the processors 1010 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1012 and a processor 1014 that may execute the instructions 1016. The term “processor” is intended to include multi-core processors that may comprise two or more independent processors (sometimes referred to as “cores”) that may execute instructions contemporaneously. Although FIG. 10 shows multiple processors 1010, the machine 1000 may include a single processor with a single core, a single processor with multiple cores (e.g., a multi-core processor), multiple processors with a single core, multiple processors with multiples cores, or any combination thereof.

The memory 1030 may include a main memory 1032, a static memory 1034, and a storage unit 1036, all accessible to the processors 1010 such as via the bus 1002. The main memory 1030, the static memory 1034, and storage unit 1036 store the instructions 1016 embodying any one or more of the methodologies or functions described herein. The instructions 916 may also reside, completely or partially, within the main memory 1032, within the static memory 1034, within the storage unit 1036, within at least one of the processors 1010 (e.g., within the processor's cache memory), or any suitable combination thereof, during execution thereof by the machine 1000.

The I/O components 1050 may include a wide variety of components to receive input, provide output, produce output, transmit information, exchange information, capture measurements, and so on. The specific I/O components 1050 that are included in a particular machine will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 10510, environmental components 1060, or position components 1062, among a wide array of other components. For example, the biometric components 1056 may include components to detect expressions (e.g., hand expressions, facial expressions, vocal expressions, body gestures, or eye tracking), measure bio-signals (e.g., blood pressure, heart rate, body temperature, perspiration, or brain waves), identify a person (e.g., voice identification, retinal identification, facial identification, fingerprint identification, or electroencephalogram-based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 1064 operable to couple the machine 1000 to a network 1080 or devices 1070 via a coupling 1082 and a coupling 1072, respectively. For example, the communication components 1064 may include a network interface component or another suitable device to interface with the network 1080. In further examples, the communication components 1064 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a USB).

Moreover, the communication components 1064 may detect identifiers or include components operable to detect identifiers. For example, the communication components 1064 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code. Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 1030, 1032, 1034, and/or memory of the processor(s) 1010) and/or storage unit 1036 may store one or more sets of instructions and data structures (e.g., software) embodying or utilized by any one or more of the methodologies or functions described herein. These instructions (e.g., the instructions 1016), when executed by processor(s) 1010, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 1080 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology. General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., HTTP). Similarly, the instructions 1016 may be transmitted or received using a transmission medium via the coupling 1072 (e.g., a peer-to-peer coupling) to the devices 1070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1016 for execution by the machine 1000, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A computer-implemented method for comprising:
receiving meeting data at a computing device via a user interface of a software application, the meeting data comprising at least i) an indication that meeting connection data is to be included in a meeting request, and ii) an identifier for each of one or more intended meeting participants to whom the meeting request is to be sent;
in response to receiving the indication that the meeting request is to be sent to the requested meeting participants:
determining the computing device does not have network connectivity:
responsive to determining the computing device does not have network connectivity, i) associating a status value with the meeting request, the status value indicating the meeting request is to be updated with meeting connection data, and ii) adding the meeting request to an outbound queue:
subsequent to the meeting request being added to the outbound queue, determining the computing device has established network connectivity;
responsive to determining the computing device has established network connectivity, processing the meeting request in the outbound queue by:
communicating to a server a request for meeting connection data for the meeting request;
receiving the meeting connection data from the server;
adding the meeting connection data with the meeting request; and
communicating the meeting request, with the meeting connection data, to a server for distribution to each of the one or more meeting participants.

2. The computer-implemented method of claim 1, wherein associating the status value with the meeting request comprises,
adding a data element to a data structure representing the meeting request, the added data element comprising the status value indicating the meeting request should be updated with meeting connection data.

3. The computer-implemented method of claim 1, wherein associating the status value with the meeting request comprises:
creating a database entry in a table that is separate from a data structure representing the meeting request, the database entry comprising the status value and a pointer to the meeting request.

4. The computer-implemented method of claim 1, wherein receiving the meeting data further comprises:
receiving as the indication that meeting connection data is to be included in a meeting request a user selection of a meeting type, the meeting type indicating that the meeting is an online meeting requiring meeting connection data.

5. The computer-implemented method of claim 1, wherein determining the computing device does not have network connectivity further comprises:
attempting to communicate with the server and receiving an error message indicating no network connectivity.

6. A computer-implemented method comprising:
receiving at a server, from a client device executing a software application, a meeting request with meeting data comprising at least i) an identifier for each of one or more intended meeting participants to whom the meeting request is to be delivered, and ii) a status value indicating that meeting connection data is to be added to the meeting request;
processing the meeting request by:
obtaining meeting connection data for the meeting request;
adding the meeting connection data to the meeting request; and
distributing the meeting request, including the meeting connection data, to the one or more intended meeting participants specified in the meeting data of the meeting request;
wherein the status value indicating that meeting connection data is to be added to the meeting request was previously added to the meeting request at the client device in response to the software application determining the client device had no network connectivity.

7. The computer-implemented method of claim 6, further comprising:
periodically processing scheduled meetings to identify meeting requests with the status value;
in response to identifying a scheduled meeting with the status value, communicating a message over a network to a client device of a meeting organizer and prompting the meeting organizer to confirm whether to add meeting connection data.

8. The computer-implemented method of claim 6, wherein the status value is added to the meeting request at the client device in response to the client device determining the client device has no network connectivity by:
attempting to communicate with the server and receiving an error message indicating no network connectivity.

9. The computer-implemented method of claim 6, wherein the status value is added to the meeting request at the client device by:
setting a flag in metadata of a data structure representing the meeting request.

10. The computer-implemented method of claim 6, wherein the status value is added to the meeting request at the client device by:
adding an entry for the meeting request to a table, the entry indicating the meeting request requires meeting connection data.

11. A system comprising:
at least one processor; and
a memory storage device storing instructions thereon, which, when executed by the at least one processor, cause the system to perform operations comprising:
receiving meeting data at a computing device via a user interface of a software application, the meeting data comprising at least i) an indication that meeting connection data is to be included in a meeting request, and ii) an identifier for each of one or more intended meeting participants to whom the meeting request is to be sent;
in response to receiving the indication that the meeting request is to be sent to the requested meeting participants:
determining the computing device does not have network connectivity;
responsive to determining the computing device does not have network connectivity, i) associating a status value with the meeting request, the status value indicating the meeting request is to be updated with meeting connection data, and ii) adding the meeting request to an outbound queue;
subsequent to the meeting request being added to the outbound queue, determining the computing device has established network connectivity;
responsive to determining the computing device has established network connectivity, processing the meeting request in the outbound queue by:
communicating to a server a request for meeting connection data for the meeting request;
receiving the meeting connection data from the server;
adding the meeting connection data with the meeting request; and
communicating the meeting request, with the meeting connection data, to a server for distribution to each of the one or more meeting participants.

12. The system of claim 11, wherein associating the status value with the meeting request comprises:
adding a data element to a data structure representing the meeting request, the added data element comprising the status value indicating the meeting request should be updated with meeting connection data.

13. The system of claim 11, wherein associating the status value with the meeting request comprises:
creating a database entry m a table that is separate from a data structure representing the meeting request, the database entry comprising the status value and a pointer to the meeting request.

14. The system of claim 11, wherein receiving the meeting data further comprises:
receiving as the indication that meeting connection data is to be included in a meeting request a user selection of a meeting type, the meeting type indicating that the meeting is an online meeting requiring meeting connection data.

15. The system of claim 11, wherein determining the computing device does not have network connectivity further comprises:
attempting to communicate with the server and receiving an error message indicating no network connectivity.

16. A system comprising:
at least one processor; and
a memory storage device storing instructions thereon, which, when executed by the at least one processor, cause the system to perform operations comprising:
receiving at a server, from a client device executing a software application, a meeting request with meeting data comprising at least i) an identifier for each of one or more intended meeting participants to whom the meeting request is to be delivered, and ii) a status value indicating that meeting connection data is to be added to the meeting request;
processing the meeting request by:
obtaining meeting connection data for the meeting request;
adding the meeting connection data to the meeting request; and
distributing the meeting request, including the meeting connection data, to the one or more intended meeting participants specified in the meeting data of the meeting request;
wherein the status value indicating that meeting connection data is to be added to the meeting request was previously added to the meeting request at the client device in response to the software application determining the client device had no network connectivity.

17. The system of claim 16, further comprising:
periodically processing scheduled meetings to identify meeting requests with the status value;
in response to identifying a scheduled meeting with the status value, communicating a message over a network to a client device of a meeting organizer and prompting the meeting organizer to confirm whether to add meeting connection data.

18. The system of claim 16, wherein the status value is added to the meeting request at the client device in response to the client device determining the client device has no network connectivity by:
attempting to communicate with the server and receiving an error message indicating no network connectivity.

19. The system of claim 16, wherein the status value is added to the meeting request at the client device by:
setting a flag in metadata of a data structure representing the meeting request.

20. The system of claim 16, wherein the status value is added to the meeting request at the client device by:
adding an entry for the meeting request to a table, the entry indicating the meeting request requires meeting connection data.
